(19) United States
(12) Patent Application Publication
(10) Pub. No.: US 2003/0226275 A1
(43) Pub. Date: Dec. 11, 2003

(54) NON-ABSORBENT BREATHABLE CONTAINER

(76) Inventor: Paul E. Becke, Mundelein, IL (US)

Correspondence Address: DAVIS CHIN, 16061 S. 94TH AVENUE, ORLAND HILLS, IL, 60477-4623, US

(21) Appl. No.: 10/249,676

(22) Filed: Apr. 29, 2003

Related U.S. Application Data
(60) Provisional application No. 60/387,457, filed on Jun. 10, 2002.

(51) Int. Cl. F26B 11/12

(52) U.S. Cl. 34/181; 220/592.01

(57) ABSTRACT

A bag, envelope, box, bottle, or any other type of container constructed of a non-absorbent breathable material such that gas and vapor can transfer from inside of the container to the outside with minimal liquid leakage. The purpose of this invention is to control the environment within the container and prevent bacterial growth, mildew growth, odor generation, moisture-based decay, oxidation, or corrosion of contents using the breathability of the container. The container is used to hold damp materials or materials wetted with volatile substances, such as water, saline, sweat, oil, or other solvents. It can also be used to hold materials that may contain residual solvent from the manufacturing process, or materials that required continued exposure to air to keep them from setting such as some adhesives and coatings. The container may be either reusable or disposable.

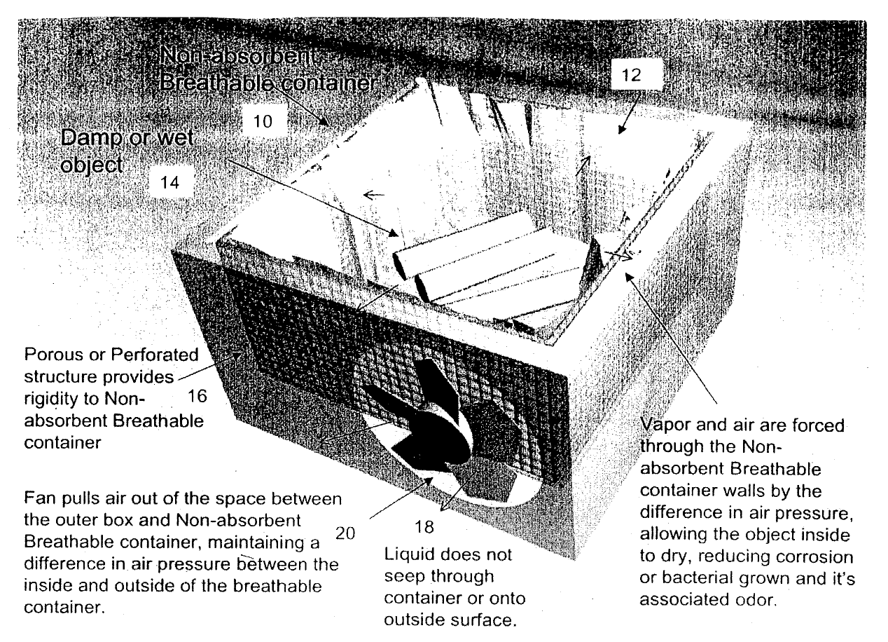

### CROSS REFERENCE TO RELATED APPLICATIONS

This application is a continuation-in-part of provisional application Serial No. 60/387,457 filed on Jun. 10,2002.

### BACKGROUND OF INVENTION

1. Field of the Invention

The present invention relates generally to breathable containers, and more particularly, it relates to breathable containers constructed of breathable films to prevent bacterial growth, mildew growth, odor generation, moisture-based decay, oxidation, and/or corrosion of contents from wet or damp materials placed within the containers.

2. Description of the Prior Art

The prior art appears to be best exemplified in the follow were developed in a search in the United States Patent and Trademark Office directed to the application: 4,829,0966,114,0244,900,3856,191,2215,560,5086,261,6985,695,8686,264,8645,959,05

In U.S. Pat. No. 4,900,385 to Ochi et al., there is disclosed a method for forming a double wall container by laminating a thermoplastic resin sheet for a container main body and a breathable thermoplastic resin sheet or film for an inner body. The container main body and the breathable inner body are separated with a prescribed distance from each other to prevent the contents from becoming sticky and keeps them fresh.

In U.S. Pat. No. 5,560,508 to Hsu, there is disclosed a laundry container structure which includes a base seat, an upper frame, four support columns and four wall boards. Four hook members are disposed under the four corners of the upper frame in which the periphery of an opening of a laundry net can be hooked and hung on the hooked members. The clothes to be washed are placed in the laundry net and can be subsequently taken out of the container and thrown into a washing machine for washing.

The other remaining patents developed from the search but not specifically discussed above merely show various methods for manufacturing breathable films and the different uses for such films. However, none of the prior art patents uncovered from the search teach or suggest a container like that of the present invention which is made of a breathable film so to prevent bacterial growth, mildew growth, odor generation, moisture-based decay, oxidation, and/or corrosion from wet or damp materials placed within the container.

Containers today are primarily constructed of breathable or non-breathable materials. Breathable containers made of plastic or fabric are constructed with pores or holes large enough to allow water to pass freely (i.e., vegetable bags) or a woven or non-woven fabric which absorbs some liquid and allows the remaining liquid to pass through (i.e., cotton, nylon, or polypropylene non-woven bags). The pores or holes in these containers are breathable in that they allow for exchange of liquid and gases between the inside and outside of the container. The holes in these containers may occur due to the process used to create the plastic or fabric (i.e., spunbound non-woven process, meltblown non-woven process, or weaving process). These holes do not require secondary perforation. The holes may also be created in an otherwise solid material via hot needle perforation, vacuum perforation, or other means. Non-breathable containers are also made of similar plastic or fabric materials except the resultant container is completely impervious to liquid or gas transfer and, thereby, retains all the liquid or gas within the container along with the contents.

While these containers are beneficial for certain uses, the inherent qualities of these containers create several problems. First, due to the size and number of holes in these containers, the container is permeable to liquid and, therefore, permits the liquid to seep onto adjacent surfaces. As a result, the liquid can cause damage to the adjacent surfaces depending upon the material of that surface and precipitates an uncleanly environment. Second, the size and number of holes allows for odor emanating from bacterial growth, mildew growth, moisture-based decay, oxidation, and/or corrosion to be freely released into the surrounding environment. Lastly, for the non-breathable containers, these containers do not control the environment inside the package due to it constricting the liquid or gas within the container. This lack of control allows for bacterial growth, mildew growth, odor generation, moisture-based decay, oxidation, or corrosion of the contents within the container due to the constricted liquid and gas. Thus, there is a need and there has never been disclosed a container constructed to incorporate the advantages provided by breathable films while minimizing the problems presented by containers that provide unsanitary conditions from the wet or damp contents and liquid seepage.

### SUMMARY OF INVENTION

Accordingly, it is a general object of the present invention to provide a non-absorbent breathable container for preventing bacterial growth, mildew growth, odor generation, moisture-based decay, oxidation, or corrosion of contents within the container which has been traditionally unavailable.

It is an object of the present invention to provide a non-absorbent breathable container so as to obviate the liquid seepage from the container.

It is another object of the present invention to provide a quality breathable container which is relatively inexpensive to manufacture and assemble.

It is still another object of the present invention to provide a breathable container which is safe and easy to use.

In accordance with these aims and objects, the present invention is concerned with the provision of a breathable container to control the environment within the container and prevent bacterial growth, mildew growth, odor generation, moisture-based decay, oxidation, or corrosion of contents using the breathability of the container. It is a further purpose of the invention to control the environment outside of the container by minimizing leakage onto adjacent surfaces and the resulting unsanitary conditions. The breathable container consists of a bag, envelope, box, bottle, or any other type of container constructed of non-absorbent breathable material such that gas and vapor can transfer from inside of the container to the outside with minimal liquid leakage. The container is used to hold damp materials or materials wetted with volatile substances, such as water, saline, sweat, oil, or other solvents. It can also be used to hold materials that may contain residual solvent from the manufacturing process, or materials that required continued exposure to air to keep them from setting such as some adhesives and coatings. The container may be either reusable or disposable.

### BRIEF DESCRIPTION OF DRAWINGS

These and other objects and advantages of the present invention will become more fully apparent from the following detailed description when read in conjunction with the accompanying drawing in which there is shown a pictorial representation of a container for carrying out the process of the instant invention.

### DETAILED DESCRIPTION

Referring now in detail to the drawing of the particular illustration, there is illustrated a non-absorbent breathable container 10 for controlling the environment inside and outside of the container, constructed in accordance with the principles of the present invention. As can be seen, a bag, envelope, box, bottle, or any other similar or related type of container 10 constructed of non-absorbent breathable material 12 such that gas and vapor can move or transfer from the inside to outside of the container with minimal liquid leakage for the purpose of controlling the environment both inside and outside of the container. The container is used to hold damp materials 14 or materials saturated with volatile substances including but not limited to water, saline, sweat, oil, or any other solvents. The container can also be used to hold materials that may contain residual solvent from the manufacturing process. The container may be either reusable or disposable.

For the purposes of this invention, breathability will be defined as the amount of water vapor that passes through a known area of the material in a known time. A standard test for this physical property is the Mocon Water Vapor Transmission Test. There is also an ASTM method using a cup of water in a controlled environment (ASTM Method E96). To be effective at controlling the environment within the package, the breathable container must have a minimum breathability of 300 grams/meter²/day as measured by either test.

In addition to the breathability of the container, the ability to prevent liquid seepage is also an important concern in the present invention. Certain types of breathable materials have more preferred characteristics in this regard. The Hydrostatic Pressure Test is a measure of the liquid barrier properties of a material. In general, the Hydrostatic Pressure Test, or referred to sometimes as hydrohead, determines the height of water (in centimeters) in a column which the material will support before a predetermined amount of water passes through it. A material with a higher hydrohead value indicates that it is a greater barrier to liquid penetration than a material having a lower hydrohead value. The Hydrostatic Pressure Test is performed according to Method 5514—Federal Test Methods Standard No. 191A. Therefore, materials such as cotton or polypropylene non-woven bags have low values of hydrostatic pressure and are not preferred embodiments of this invention. In order to be effective for preventing liquid seepage, the breathable container must have a minimum hydrohead of about 10 centimeters. A preferred value would be on the order of 25 centimeters of hydrohead.

The container may also be made by lining or laminating a breathable material to another material 16 to provide rigidity, flexibility, strength, tear resistance, or chemical resistant properties to the container. The lining or laminating may be affixed to any material including but not limited to cardboard or any type of stiff paper provided that the material shows characteristics of rigidity, flexibility, strength, tear resistance, or chemical resistant properties. Preferably, the cardboard or any type of paper or material is perforated with holes. While this material may reduce the transfer of gas and vapor from the container somewhat, the perforation prevents the cardboard, paper, or material from fully obstructing the transfer of gas and vapor from the container, thereby, reaping the benefits of the material.

In a preferred embodiment, the container is used to hold soiled laundry, damp clothing, or other materials that are susceptible to bacterial growth, mildew growth, or odor generation if held in a damp state for extended periods. In an alternate embodiment, the container is used to hold damp food materials that are susceptible to moisture-based decay. In a third alternate embodiment, the container is used to hold materials that are susceptible to solvent-based corrosion from residual solvent from the manufacturing process such as metal fittings. In a fourth alternate embodiment the container is used to hold materials that require continued exposure to air to keep the materials from hardening or drying in the absence of the air. Such materials include but are not limited to adhesives and coatings, for example, clear coat paint.

In a fifth alternate embodiment, the container is used to hold animal waste for controlling odor and bacterial growth without liquid seepage. The container can be placed in a stream of air 18 created by a fan 20 in order to increase the exchange of air between the inside and outside of the container. The container may also be placed in an environment so to maintain a difference of air pressure between the inside and outside of the container for increasing the exchange of air therebetween. The container may be further constructed either of a microporous or monolithic breathable film or sheet material; a co-extrusion or laminate of microporous and monolithic materials; or multi-layers of breathable and non-breathable materials in which the non-breathable materials are perforated.

In a comparative analysis, the performance of a breathable laundry bag used to hold damp clothing articles was compared to that of a non-breathable polyethylene bag used to hold the same material. The breathable laundry bag was constructed of a breathable film, which is commercially available from Tredegar Film Products of Richmond, Va. under their product code XBF-763. When removed from the bag after 24 hours, the clothing articles in the breathable laundry bag had substantially less odor than the clothing articles that were stored in the non-breathable bag. In addition, the clothing articles from the breathable bag contained much less moisture than those stored in the non-breathable bag. Finally, there was little or no transfer of liquid from the breathable bag onto the surface on which it was stored.

In view of the foregoing description, it can be seen that there has been provided a unique container that incorporates breathability to control the environment inside and outside of the package, thereby minimizing bacterial growth, mildew growth, odor generation, moisture-based decay, oxidation, and/or corrosion while preventing liquid seepage or leakage and the ensuing the unsanitary problems presented from the contents within the container.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

1. A breathable container for controlling the environment inside and outside of the container, comprising in combination:
damp materials disposed inside of said breathable container and;
said breathable container being formed of a non-absorbent breathable material such that water vapor from said damp material is transferred from the inside of said breathable container to the outside so as to prevent bacterial growth, mildew growth, odor generation, moisture-based decay, oxidation, or other corrosion from said damp materials within said breathable container.

2. A breathable container as claimed in claim 1, wherein said breathablecontainer is constructed of microporous breathable film or sheet material.

3. A breathable container as claimed in claim 1, wherein said breathable container is constructed of monolithic breathable material.

4. A breathable container as claimed in claim 1, wherein said breathable container is constructed of a co-extrusion or laminate of microporous and monolithic materials.

5. A breathable container as claimed in claim 1, wherein said breathable container construction is a multi-layered construction of breathable and non-breathable materials where the non-breathable materials are perforated.

6. A breathable container as claimed in claim 1, wherein said breathable container contains support structures constructed of breathable or non-breathable materials.

7. A breathable container as claimed in claim 1, wherein said breathable container is a bag.

8. A breathable container as claimed in claim 1, wherein said breathable container is an envelope.

9. A breathable container as claimed in claim 1, wherein said breathable container is a box.

10. A breathable container as claimed in claim 1, wherein said breathable container is a bottle.

11. A breathable container as claimed in claim 1, wherein said damp materials include damp or soiled clothing or other textiles and said container controls water seepage and mildew or bacterial growth, thereby resulting in reduced odor and dry storage surfaces as well as reduced damage to the contained articles and storage surface.

12. A breathable container as claimed in claim 1, wherein said damp materials include food or produce and said container controls water or juice seepage and mildew or bacterial growth, thereby resulting in reduced odor and dry storage surfaces as well as reduced damage to the contained articles and storage surface.

13. A breathable container as claimed in claim 1, wherein said damp materials include manufactured parts and assemblies susceptible to solvent-based corrosion and said container controls the evaporation and seepage of residual solvent from said manufactured parts and assemblies, thereby resulting in reduced corrosion of the parts and the storage surface.

14. A breathable container as claimed in claim 1, wherein said damp materials include manufactured parts and assemblies having a coating and said container controls the evaporation and seepage of the coating from manufactured parts and assemblies, thereby resulting in a cleaner storage surface.

15. A breathable container as claimed in claim 1, wherein said damp materials include animal waste and said container controls odor and bacterial growth without liquid seepage.

16. A breathable container as claimed in claim 1, wherein said damp materials include articles such as adhesives or coatings that require exposure to air in order to prevent curing.

17. A breathable container as claimed in claim 1, wherein said damp materials include articles that have been coated and require exposure to air in order to prevent the coating from curing.

18. A breathable container as claimed in claim 1, wherein said container is disposable.

19. A breathable container as claimed in claim 1, wherein said container is capable of being laundered or otherwise reused.

20. A breathable container as claimed in claim 1,wherein said container is placed in a stream of air to increase the exchange of air between the inside and the outside of the container.

21. A breathable container as claimed in claim 1, wherein a difference in air pressure is maintained between the inside and outside of the container to increase the exchange of air between the inside and the outside of the container.
